(19) United States
(12) Patent Application Publication
(10) Pub. No.: US 2007/0095618 A1
(43) Pub. Date: May 3, 2007

(54) Structure to operate and to dismantle/assemble dual-use sickbed and wheel chair

(76) Inventor: Chin-Lung Lai, Huatan Township (TW)

Correspondence Address: TROXELL LAW OFFICE PLLC, SUITE 1404, 5205 LEESBURG PIKE, FALLS CHURCH, VA, 22041, US

(21) Appl. No.: 11/484,656

(22) Filed: Jul. 12, 2006

(30) Foreign Application Priority Data
Oct. 14, 2005 (TW) 094217755

(51) Int. Cl. A61G 7/015

(52) U.S. Cl. 188/2 F; 5/620; 5/618

(57) ABSTRACT

An improved structure to operate and to dismantle/assemble dual-use sickbed and wheel chair, which is comprised by bed & chair, hemicycle disc gear, block structure, check structure and linkage structure, wherein shaft of block structure is fixed at lever or at bottom of lever basing on right cable housing of right brake crank, and another end protrudes into position hole of disc gear; L-pull rod of gear shift is pushed against ratchet of disc gear or fixed at L-pull rod by left cable housing of left brake crank, hold left brake crank to prevent L-pull rod from dropping off disc gear, so that disc gear can only rotate in single direction. As disc gear drives chair back to rotate, main link rod can move at the same time so that passive rod and connection rod drive chair back to rotate in reverse direction, chair back and mat also elevate in reverse direction; thus, either adjust chair back upward or downward, user can hold chair back with one hand while another hand pulls lever (or hold right brake crank,) or L-pull rod (or hold left brake crank), thereby, chair back and mat can be adjusted properly at any time. The packaging and transporting materials may be reduced by dismantling and assembling parts, furthermore, such structure is easy to operate.

### BACKGROUND OF THE INVENTION

1) Field of the Invention

This invention relates to an improved structure to operate and to dismantle/assemble dual-use sickbed and wheel chair, wherein chair back and mat can be elevated in reverse direction. Either adjust chair back upward or downward, user can hold chair back with one hand while another hand pull up lever (or hold right brake crank) or L-pull rod (or hold left brake crank) so as to adjust angle of bed and chair back properly. Furthermore, chair back, mat and armrest can be dismantled from chair seat, so, it can occupy less room in packing and operate easily.

2) Description of the Prior Art

Usually, the medical facilities for patient to sit down and sleep include sickbed and wheel chair, however, above said two types of medical facility are solely applied, so, it is inconvenient to use since they can not be applied together. If want to help wash patient, you must first push patient to ablution field with wheel chair, then carry patient to ablution unit. At end of wash, you once again carry patient into wheel chair and push patient into sickroom, then take back sickbed. Such movements may cause patient to feel discomfort or collide the sore parts. Moreover, it may aggravate burden of nursing dependents or personnel.

In view of above said shortage, inventor of this invention has finally invented this improved structure to operate and to dismantle/assemble dual-use sickbed and wheel chair after years research.

### SUMMARY OF THE INVENTION

An improved structure to operate and to dismantle/assemble dual-use sickbed and wheel chair, wherein shaft of block structure is fixed at lever or at bottom of lever basing on right cable housing of right brake crank, and another end protrudes into position hole of disc gear; L-pull rod of gear shift is pushed against ratchet of disc gear or fixed at L-pull rod by left cable housing of left brake crank, hold left brake crank to prevent L-pull rod from dropping off disc gear, so that disc gear can only rotate in single direction. As disc gear drives chair back to rotate, main link rod can run at the same time so that passive rod and connection rod drive chair back to rotate in reverse direction, chair back and mat elevate also in reverse direction; thus, either adjust chair back upward or downward, user can hold chair back with one hand while another hand pull lever or L-pull rod, or hold left &right brake handle to pull L-pull rod or lever, thereby, chair back or mat can be adjusted properly at any time. Such structure can be operated easily and also applied to sickbed and wheel chair.

### BRIEF DESCRIPTION OF THE DRAWINGS

FIG. 1 is the exploded view of this invention.

FIG. 1-A is the plane section of block structure.

FIG. 1-B is another embodiment view of disc gear.

FIG. 2 is the exploded combination view of this invention.

FIG. 3-A is the side view of disc gear of this invention.

FIG. 3-B is the embodiment view of block structure in blocking state.

FIG. 3-C is the embodiment view of block structure in release state.

FIG. 4-A is the embodiment view of bed & chair in lying-down state.

FIG. 4-B is the embodiment view of bed & chair in sitting-up state.

FIG. 5 is the disassembled sketch map of structure of this invention.

FIG. 5-A is the palletized sketch map of shrunk cubage of this invention.

### DETAILED DESCRIPTION OF THE INVENTION

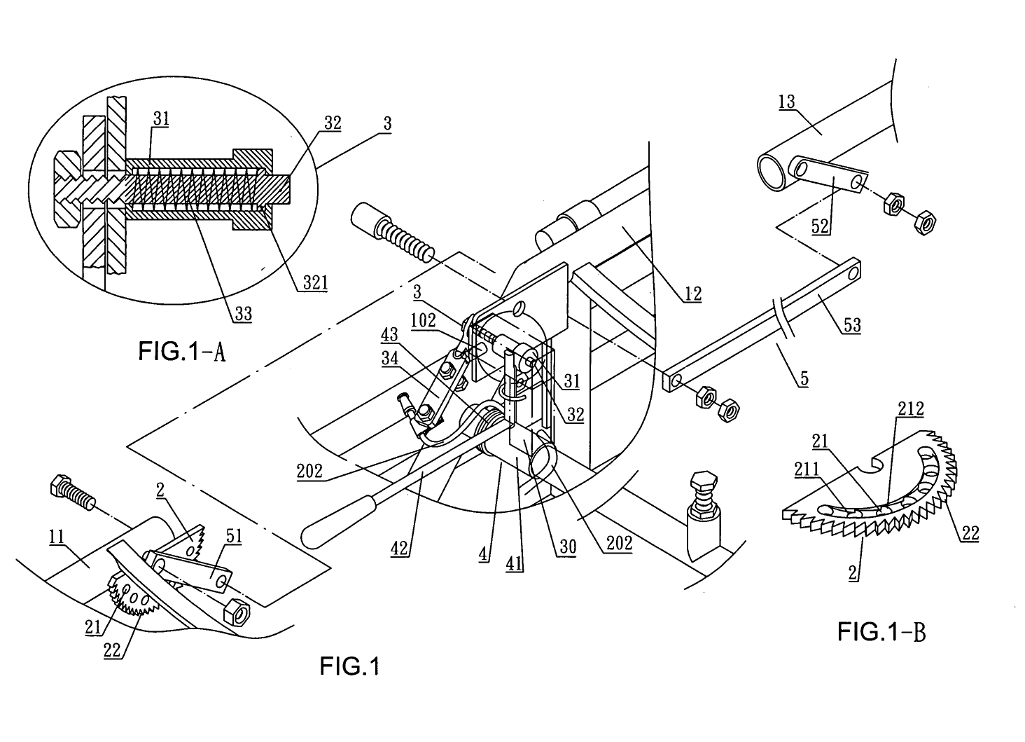

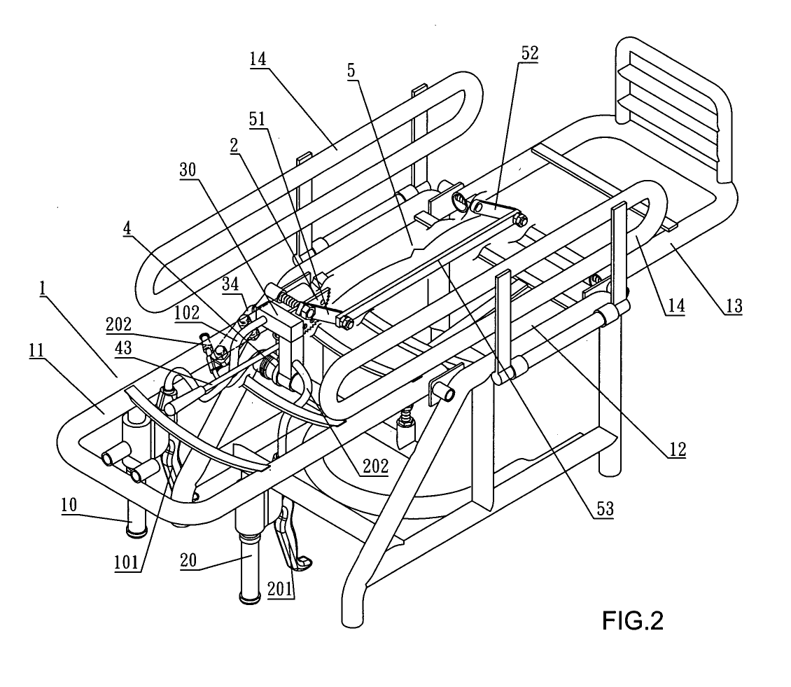

Please refer to FIG. 1 and FIG. 2 for detailed structure of this invention. This invention is comprised by bed & chair 1, disc gear 2, block structure 3, check structure 4 and linkage structure 5 to let chair back and mat elevate in reverse direction; wherein

Hemicycle disc gear 2 is fixed at chair back 11 of bed & chair, position hole 21 is set on disc gear 2, and position holes 21 are arranged in slanting (as shown in FIG. 1-B) so as to embed shaft 32 of block structure into the said holes, which is in cut block with shaft;

Block structure is comprised by external bushing 31 of side board 12 passing through bed &chair, shaft 32 fixed at lever 34 covering onto external bushing 31 and spring 33 covering onto shaft 32 and external bushing 31 (as shown in FIG. 1-A). In addition, after spring 33 is covered onto shaft 32, extend one ring 321 at proper position of shaft, another end of shaft 32 protrudes into position hole 21 of disc gear 2 in slanting so that disc gear is pushed against shaft 32 to compress spring 33 slightly along gradient when rotating, which is in cut block with shaft 32;

Check structure 4 is to cover bushing 41 onto horizontal rod 121 at chair seat of bed & chair in advance, L-pull rod 42 is vertically fixed at bushing 41, in addition, a torque spring 43 is also fixed around horizontal rod 121, another end of torque spring 43 hooks L-pull rod 42; vertical top of L-pull rod 42 is pushed against ratchet 22 of disc gear 2 so as to block disc gear 2 from rotating; linkage structure 5 is comprised by active rod 51 fixed on disc gear 2, passive rod 52 fixed at side of mat 13 and connection rod connected between active/passive rod; active rod 5 may move at the same time when disc gear 2 drives chair back 11 to rotate, so that passive rod 52 and connection rod 53 drive mat 13 to rotate in reverse direction;

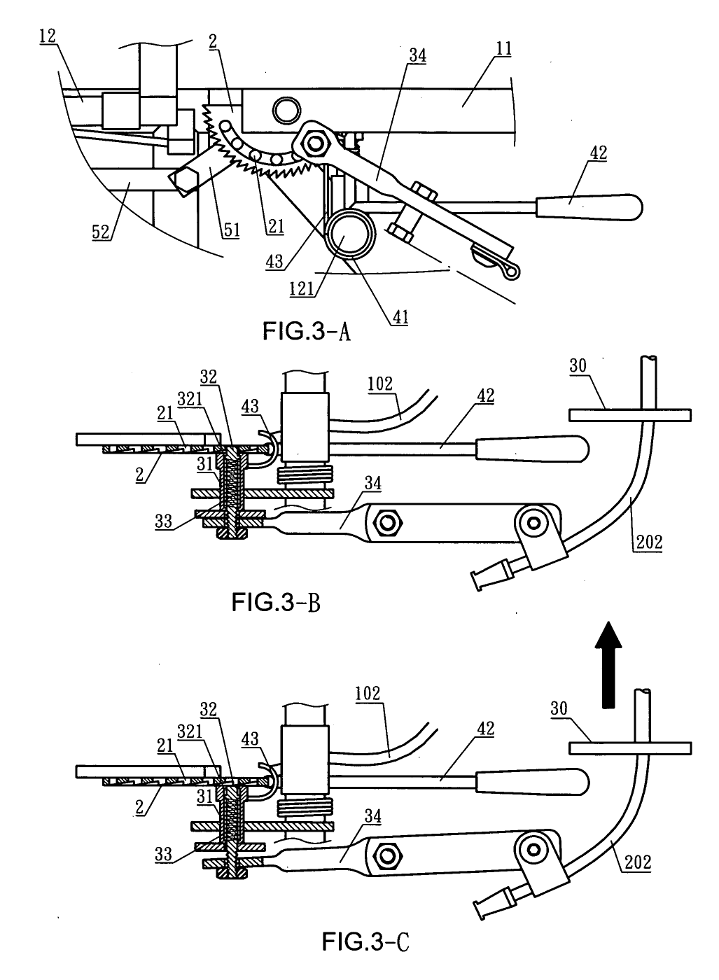

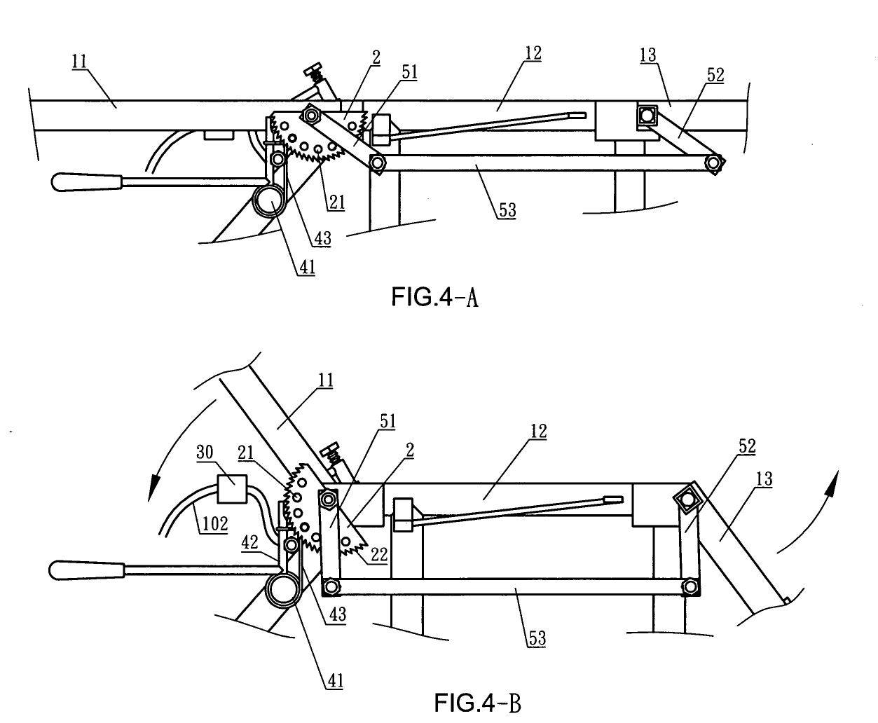

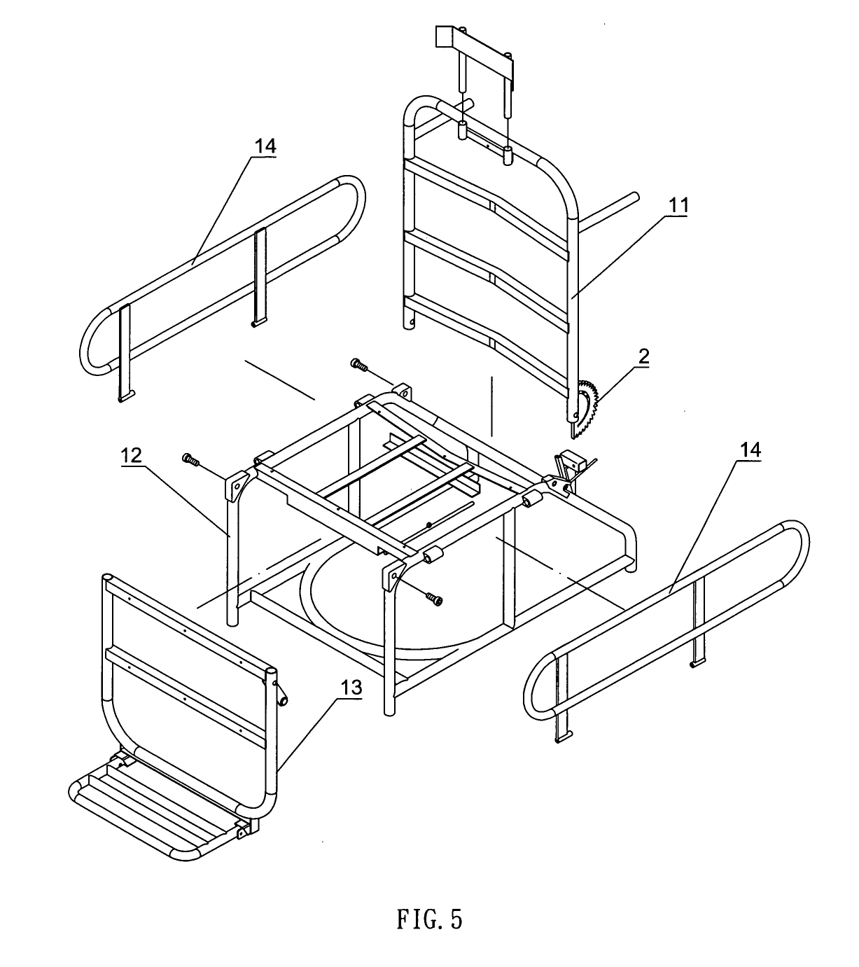

Please refer to FIG. 3 and FIG. 4 for movement mode, if want to ascend chair back 11, must push lever 34 outward so that shaft 32 compresses spring 33 to pull out position hole 21 of disc gear, thereby, user can adjust chair back 11 upward, and ratchet 22 of disc gear can slide along L-pull rod 42 in single direction, chair back 11 can only ascend but not descend due to block of L-pull rod 42 (because L-pull rod moves forward from lower end of ratchet to high end, so, high end is blocked in reverse direction and cannot move); mat 13 is pulled downward by active/passive rod 51/52 of linkage structure, when it is adjusted to the required position, please release lever 34 so that shaft 32 is pushed back its original position to embed into position hole 21 of disc gear 2, chair back 11 and mat 13 are positioned actually (as shown in FIG. 3-B and FIG. 4-A);

User must pull down L-pull rod 42 in advance when descending chair back 11, so that L-pull rod 42 pulls torque spring 43 properly to let it drop off disc gear 2, user can descend chair back 11, disc gear 2 is blocked into shaft 32 of position hole 21 of disc gear when rotating, push shaft 32 to compress spring 33 along gradient of position hole 21 (move from low end 211 to high end 212, high end is blocked in reverse direction and cannot move), shaft 32 is in cut blocking state that can prevent chair back from folding down quickly, mat 13 is pulled upward by active/passive rod 51/52 of linkage structure, when it is adjusted to the required position, please release lever 34 so that L-pull rod 42 is pulled by torque spring 43 to return to its original position, so, chair back and mat are positioned actually (as shown in FIG. 3-C and FIG. 4-B);

When chair back 11 is ascending, L-pull rod 42 moves from low end to high end of ratchet 22, so that disc gear 2 can only rotate in single direction, high end of ratchet 2 is blocked in reverse direction and cannot descend, therefore, even if left go of it when adjusting chair back 11, it couldn fold down quickly.

Either ascend or descend chair back 11, user can hold chair back 11 with one hand while another hand pulls lever 34 or L-pull rod 42 so as to position angle of bed & chair 1, therefore, such structure can be operated easily and also applied to sickbed and wheel chair.

Please refer to FIG. 2, left/right brake crank 101/201 is respectively fixed at left/right handle 10/20 of above said bed & chair, and left/right cable housing 102/202 are limited by relay position base 30 so that left cable housing 102 is fixed at front of above said L-pull rod 42 and right cable housing 202 is fixed at bottom of lever 34, user can hold left crank 101 to control L-pull rod 42 and hold right crank 201 to control lever 34, so, to control left/right brake crank 101/201 is equal to controlling L-pull rod and lever 34 directly, therefore, such structure is easy to operate.

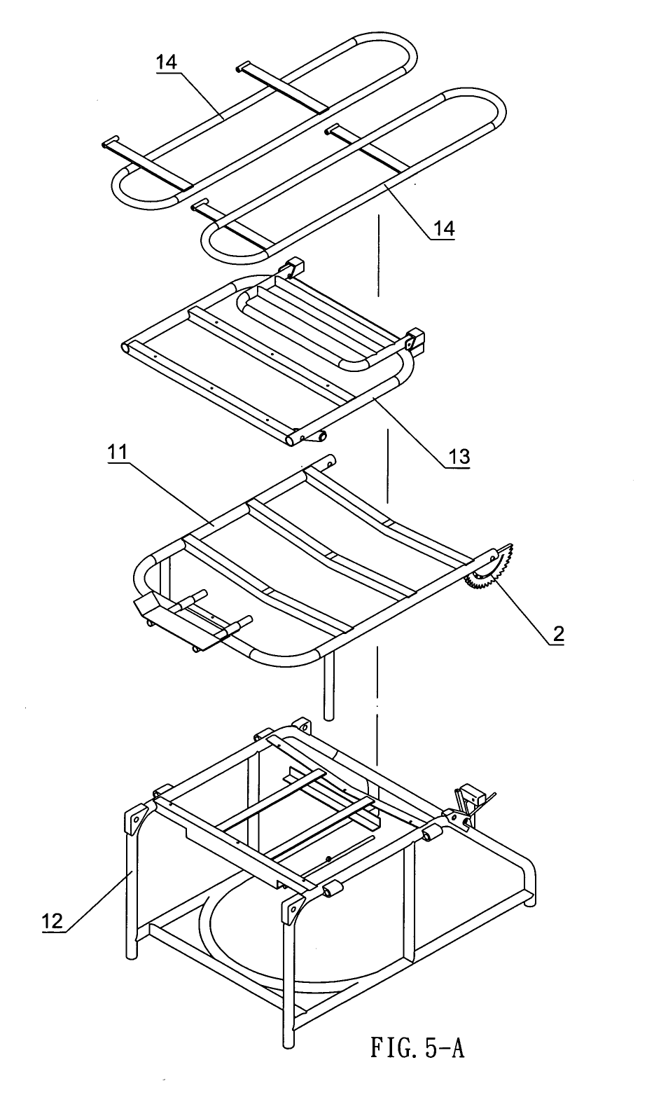

Furthermore, please refer to FIG. 5 and FIG. 5-A, chair back 11, mat 13 and armrest 14 in this invention can be dismantled from chair seat 12 respectively, so that cubage of whole structure can be shrunk if properly palletized, packaging and transporting materials may be further reduced accordingly, therefore, it will occupy less room (please refer to FIG. 5-A for cubage shrinking).

What is claimed is:

1. An improved structure to operate and to dismantle/assemble dual-use sickbed and wheel chair, which is comprised by bed & chair, hemicycle disc gear, block structure, check structure and linkage structure, wherein:
Concave position hole is made in this disc gear, all position holes are arranged in slanting so that shaft of bushing can be embedded into;
Block structure is comprised by external bushing of side board passing through bed & chair, shaft fixed at lever covering onto external bushing, spring covering onto shaft and external bushing. In addition, after spring is covered onto shaft, extend one ring at proper position of shaft, another end of shaft is protruded into position hole of disc gear so that it is pushed against shaft to compress spring slightly along gradient of position hole;
Check structure is to cover one bushing onto horizontal rod at chair seat of bed & chair in advance, L-pull rod is vertically fixed at bushing, in addition, a torque spring is also fixed around horizontal rod, another end of torque spring hooks L-pull rod; vertical top of L-pull rod is pushed against ratchet of disc gear so that it can only rotate in single direction;
Linkage structure is comprised by active rod fixed at disc gear, passive rod and connection rod connected between active/passive rod; when disc gear drives mat to rotate, main link rod moves at the same time, passive and connection rod drive chair back to rotate in reverse direction, so that chair back and mat elevate in reverse direction;
Thereby, such structure can be operated easily and also applied to sickbed and wheel chair.

2. As claimed in claim 1, it is an improved structure to operate and to dismantle/assemble dual-use sickbed and wheel chair, which is comprised by bed & chair, wherein chair back, mat and armrest can be dismantled into single unit, so, it will occupy less room due to reduction of packaging and transportation materials.

3. As claimed in claim 1, it is an improved structure to operate and to dismantle/assemble dual-use sickbed and wheel chair, wherein disc gear is fixed at side of chair back of bed & chair, passive rod of linkage structure is fixed at side of mat of bed & chair, passive rod and disc gear are fixed at the same side.

4. As claimed in claim 1, it is an improved structure to operate and to dismantle/assemble dual-use sickbed and wheel chair, wherein left/right brake crank is respectively fixed at left/right handle of above said bed & chair, and left/right cable housing are limited by relay position base so that left cable housing is fixed at front of above said L-pull rod and right cable housing is fixed at bottom of lever, user can hold left crank to control L-pull rod and right crank to control lever, so, to control left/right brake crank is equal to controlling L-pull rod and lever directly, therefore, such structure is easy to operate.
